(19) United States
(12) Patent Application Publication
(10) Pub. No.: US 2008/0036947 A1
(43) Pub. Date: Feb. 14, 2008

(54) Liquid crystal display device with polarizer having light guide layer

(75) Inventors: Che-Kuei Mai, Miao-Li (TW); Kai Meng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/891,753

(22) Filed: Aug. 13, 2007

(30) Foreign Application Priority Data
Aug. 11, 2006 (TW) 95129590

(51) Int. Cl. G02F 1/1335

(52) U.S. Cl. 349/96

(57) ABSTRACT

An exemplary LCD device (2) includes a liquid crystal panel (23), a light source (25), and a polarizer (24). The polarizer has a multilayer structure having a polarizing layer (245) and a light guide layer (247). The polarizer is adjacent to a main face of the liquid crystal panel. The light source is disposed adjacent to a peripheral edge of the light guide layer. The light source and the polarizer cooperate to provide a substantially planar light source to illuminate the liquid crystal panel.

### FIELD OF THE INVENTION

The present invention relates to liquid crystal display (LCD) devices, and particularly to an LCD device with a polarizer having a light guide layer.

### BACKGROUND

A typical liquid crystal display device is capable of displaying a clear and sharp image through thousands or even millions of pixels that make up the complete image. The liquid crystal display has thus been applied to various electronic equipment in which messages or pictures need to be displayed, such as mobile phones and notebook computers. However, liquid crystal in the liquid crystal display does not itself emit light. Rather, the liquid crystal has to be lit up by a light source so as to clearly and sharply display text and images. The light source may be ambient light, or a backlight module attached to the liquid crystal display.

FIG. 5 is a schematic, exploded, side view of a conventional LCD device. The LCD device 1 includes an LCD panel 11 and a backlight module 19. The backlight module 19 is arranged under the LCD panel 11 in order to provide sufficient light beams to the LCD panel 11. Thereby, the LCD panel 11 is able to display images.

The LCD panel 11 includes a top polarizer 12, a bottom polarizer 14, and a liquid crystal (LC) panel 13. The top polarizer 12 and the bottom polarizer 14 are attached to two outer surfaces of the LC panel 13 that are at opposite sides of the LC panel 13.

The backlight module 19 includes a light source 15, a light guide plate (LGP) 16, and a reflective plate 17. The LGP 16 includes a light incident surface 161, a top light emitting surface 162 adjoining the light incident surface 161, and a bottom surface 163 also adjoining the light incident surface 161. The bottom surface 163 includes a plurality of pattern dots 160 thereat. The pattern dots 160 are in the form of recesses. The light source 15 is disposed adjacent to the light incident surface 161 of the LGP 16. The reflective plate 17 is disposed adjacent to the bottom surface 163. The LCD panel 11 is disposed adjacent to the light emitting surface 162.

Also referring to FIG. 6, this is an enlarged, side view of part of the bottom polarizer 14. The bottom polarizer 14 includes an adhesive layer 141, a top protective layer 143, a polarizing layer 145, and a bottom protective layer 147. The adhesive layer 141, the top protective layer 143, the polarizing layer 145, and the bottom protective layer 147 are arranged in that order from top to bottom. The top polarizer 12 has a structure similar to that of the bottom polarizer 14.

Light beams emitted by the light source 15 enter the LGP 16 through the light incident surface 161. Most of the light beams are reflected at the pattern dots 160 of the LGP 16, and then transmit through the light emitting surface 162. Some of the light beams transmit out of the LGP 16 through the bottom surface 163, and then are reflected back into the LGP 16 by the reflective plate 17. These light beams then also transmit through the light emitting surface 162. All the light beams passing through the light emitting surface 162 illuminate the LCD panel 11. Thereby, the LCD panel 11 is able to display images.

The LCD device 1 includes the LCD panel 11 and the backlight module 19. The backlight module 19 in particular is typically quite thick, and adds significantly to the overall thickness of the LCD device 1. That is, the LCD device 1 typically occupies much space. This means the LCD device 1 cannot be used in certain applications and environments which are space critical.

Accordingly, what is needed is an LCD device that can overcome the above-described deficiencies.

### SUMMARY

An exemplary LCD device includes a liquid crystal panel, a light source, and a polarizer. The polarizer has a multilayer structure having a polarizing layer and a light guide layer. The polarizer is adjacent to a main face of the liquid crystal panel. The light source is disposed adjacent to a peripheral edge of the light guide layer. The light source and the polarizer cooperate to provide a substantially planar light source to illuminate the liquid crystal panel.

Another exemplary LCD device includes a liquid crystal panel, a light source, and an optical film. The optical film includes a light guide layer configured for guiding and converting light beams emitted from the light source to a substantially planar light source, and a polarizing layer configured for polarizing light of the substantially planar light source such that the polarized light illuminates the liquid crystal panel.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, side cross-sectional view of an LCD device according to a first embodiment of the present invention, the LCD device including a bottom polarizer and a light source, essential optical paths also being shown.

FIG. 2 is an enlarged view of the light source and part of the bottom polarizer of the LCD device of FIG. 1.

FIG. 3 is an exploded, side cross-sectional view of an LCD device according to a second embodiment of the present invention, the LCD device including a polarizer, essential optical paths also being shown.

FIG. 4 is an enlarged view of part of the polarizer of the LCD device of FIG. 3.

FIG. 5 is an exploded, side cross-sectional view of a conventional LCD device, the LCD device including a bottom polarizer, essential optical paths also being shown.

FIG. 6 is an enlarged view of part of the bottom polarizer of the LCD device of FIG. 5.

### DETAILED DESCRIPTION OF PREFERRED EMBODIMENTS

Reference will now be made to the drawings to describe embodiments of the present invention in detail.

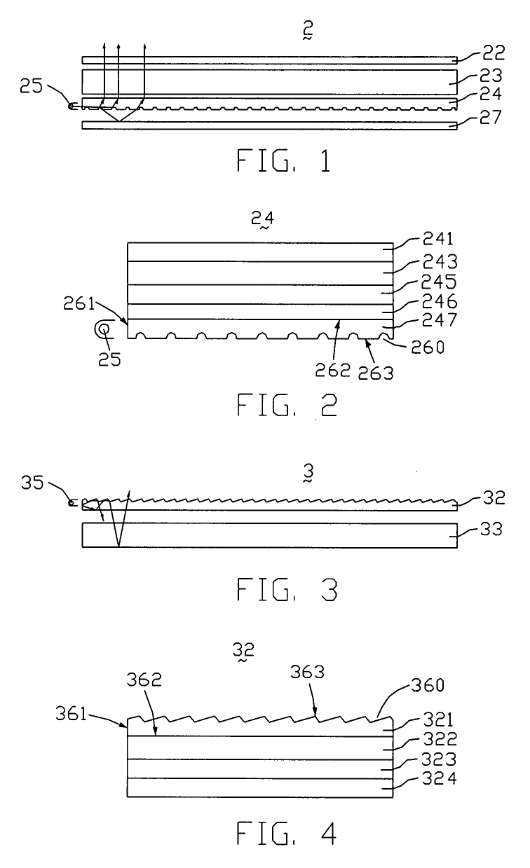

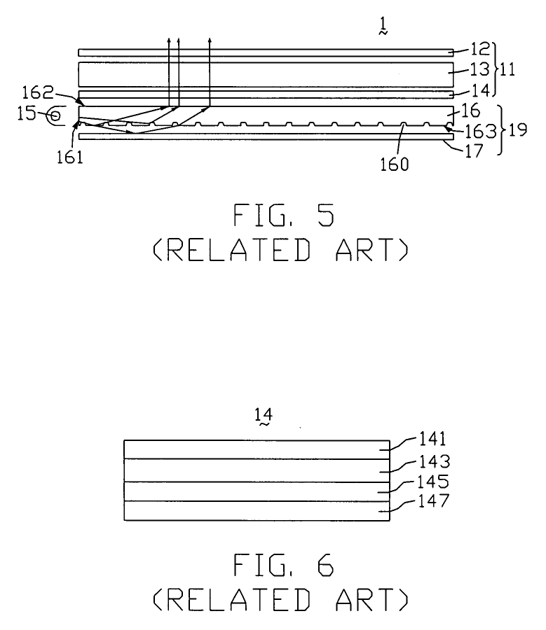

Referring to FIG. 1, this is an exploded, side view of an LCD device according to a first embodiment of the present invention. The LCD device 2 includes a top polarizer 22, an LC panel 23, a bottom polarizer 24, a reflective plate 27, and a light source 25. The top polarizer 22, the LC panel 23, the bottom polarizer 24, and the reflective plate 27 are arranged in that order from top to bottom. The light source 25 is disposed at one side edge of the bottom polarizer 24. The light source 25 can for example be a light emitting diode (LED) or a cold cathode fluorescent lamp (CCFL). The LC panel 23 can be a transmission type LC panel or a transflective type LC panel.

Also referring to FIG. 2, this is an enlarged, side view of the light source 25 and part of the bottom polarizer 24. The bottom polarizer 24 includes an adhesive layer 241, a top protective layer 243, a polarizing layer 245, a diffusion layer 246, and a bottom protective light guide layer 247. The adhesive layer 241, the top protective layer 243, the polarizing layer 245, the diffusion layer 246, and the bottom protective light guide layer 247 are arranged in that order from top to bottom. The bottom protective light guide layer 247 is used for guiding and converting light beams emitted from the light source 25 to a substantially planar light source. When the substantially planar light eventually emits from the adhesive layer 241, the substantially planar light illuminates the LC panel 23.

The bottom protective light guide layer 247 includes a top boundary 262 adjacent to the diffusion layer 246, a light incident surface 261 adjoining the top boundary 262, and a bottom surface 263. The bottom surface 263 includes a plurality of pattern dots 260 thereat. In the illustrated embodiment, the pattern dots 160 are in the form of recesses. The light source 25 is disposed adjacent to the light incident surface 261.

The polarizing layer 245 is made of a polyvinyl alcohol (PVA) film, which has ductility and optical polarity. The top protective layer 243 and the bottom protective light guide layer 247 are made of material with characteristics of high light transparence, water resistance, and mechanical strength; for example, triacetyl cellulose (TAC), or the like. In one embodiment, the light source 25 is an LED, which typically has a thickness (i.e. height) of 0.35 mm. The bottom protective light guide layer 247 has a thickness corresponding to that of the light source 25. That is, the thickness of the bottom protective light guide layer 247 is typically 0.35 mm or a little more than 0.35 mm. With the ongoing progress of light source technology, it is believed that the thickness of the light source 25 may be less than 0.35 mm. Whatever the thickness of the light source 25, the bottom protective light guide layer 247 should be correspondingly thick in order to work well with the light source 25.

A typical method of making the bottom polarizer 24 includes the following steps. Iodine ions are permeated into a PVA film. The PVA film is heated and then stretched, so that the iodine ions are rotated and become oriented in a same direction. This ensures that light beams transmitting through the PVA film can be polarized. Then the diffusion layer 246 is attached on one surface of the PVA film. The top protective layer 243 is coated on the other surface of the PVA film, and the bottom protective light guide layer 247 is coated on the diffusion layer 246, in order to protect the PVA film and prevent the PVA film from shrinking. Finally, the adhesive layer 241 is pasted on the top protective layer 243.

Light beams emitted by the light source 25 enter the bottom protective light guide layer 247 though the light incident surface 261. Most of the light beams are reflected at the pattern dots 260 of the bottom protective light guide layer 247, and then transmit through the top boundary 262 to the diffusion layer 246. Some of the light beams transmit out of the bottom protective light guide layer 247 through the bottom surface 263, and then are reflected back into the bottom protective light guide layer 247 by the reflective plate 27. These light beams then also transmit through the top boundary 262 to the diffusion layer 246. All the light beams transmitting to the diffusion layer 246 eventually illuminate the LC panel 23, which can thereby display images.

In alternative embodiments, the pattern dots 260 at the bottom surface 263 can have other suitable shapes, as long as the pattern dots 260 can provide reflection of light beams with an incident angle larger than a critical angle, and provide refraction of light beams with an incident angle less than the critical angle.

In summary, the bottom polarizer 24 of the LCD device 2 includes the bottom protective light guide layer 247. The bottom protective light guide layer 247 is capable of guiding and converting the light beams emitted from the light source 25 to a substantially planar light source, which eventually illuminates the LC panel 23 for displaying of images. With this configuration, the LCD device 2 does not need an LGP. This means an overall thickness of the LCD device 2 is reduced, so that the LCD device 2 is more compact and occupies less space.

Referring to FIG. 3, an LCD device 3 according to a second embodiment of the present invention includes a polarizer 32, an LC panel 33 arranged under the polarizer 32, and a light source 35 disposed at one side edge of the polarizer 32. The LC panel 33 is a reflection type LC panel. The light source 35 is, in general, an LED or a CCFL.

Also referring to FIG. 4, this is an enlarged, side view of part of the polarizer 32. The polarizer 32 includes a top protective light guide layer 321, a polarizing layer 322, a bottom protective layer 323, and a retardation film 324. The top protective light guide layer 321, the polarizing layer 322, the bottom protective layer 323, and the retardation film 324 are arranged in that order from top to bottom. The top protective light guide layer 321 is used for achieving a substantially planar light source for the LC panel 33, which can thereby display images. The retardation film 324 causes phase retardation of light beams passing therethrough. The retardation film 324 can for example be a quarter wave plate or a half wave plate.

The top protective light guide layer 321 includes a bottom boundary 362 adjacent to the polarizing layer 322, a light incident surface 361 adjoining the bottom boundary, and a top surface 363 adjoining the light incident surface 361. The top surface 363 defines a plurality of elongate grooves 360 thereat. Each of the grooves 360 is substantially parallel to the light incident surface 361. All the grooves 360 have the same configuration. In particular, each groove 360 has a generally V-shaped configuration as viewed from a lateral side of the LCD device 3. Each groove 360 is bounded by two face portions of the top surface 363. Ridges of the top surface 363 between the grooves 360 are coplanar. The common plane shared by the ridges is perpendicular to the light incident surface 361. For each groove 360, an absolute value of an angle of a first one of the face portions nearer to the light incident surface 361, relative to a plane parallel to the light incident surface 361, is less than an absolute value of an angle of the other second face portion farther from the light incident surface 361, relative to the same plane parallel to the light incident surface 361. Thus, the first face portion and the second face portion have different sizes.

The grooves 360 can provide reflection of light beams that transmit up thereto when such light beams have an incident angle at the top surface 363 which is greater than a critical angle. These reflected light beams transmit back down in the top protective light guide layer 321. The grooves 360 can also provide separation of light beams with an incident angle less than the critical angle. These light beams are separated into two parts. One part of the light beams are reflected and transmit to other grooves 360. The other part of the light beams are refracted and transmit out from the top surface 363 of the polarizer 32.

Thus in operation of the LCD device 3, light beams emitted by the light source 35 transmit into the top protective light guide layer 321 through the light incident surface 361 and substantially reach the grooves 360. Then some of the light beams are reflected back down in the top protective light guide layer 321 and transmit down through the polarizer 32. Other of the light beams are reflected and transmit to other grooves 360 to be re-utilized. Still other of the light beams are refracted and transmit out from the top surface 363 of the polarizer 32. The light beams transmitting down through the polarizer 32 eventually illuminate the LC panel 33, for displaying of images by the LCD device 3.

In summary, the polarizer 32 has the top protective light guide layer 321. The top protective light guide layer 321 is capable of guiding and converting the light beams emitted from the light source 35 to a substantially planar light source, which eventually illuminates the LC panel 33 for displaying of images. With this configuration, the LCD device 3 does not need an LGP. This means an overall thickness of the LCD device 3 is reduced, so the LCD device 3 is more compact and occupies less space.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a liquid crystal panel;
a light source; and
a polarizer;
wherein the polarizer has a multilayer structure comprising a polarizing layer and a light guide layer, the polarizer is adjacent to a main face of the liquid crystal panel, the light source is disposed adjacent to a peripheral edge of the light guide layer, and the light source and the polarizer cooperate to provide a substantially planar light source to illuminate the liquid crystal panel.

2. The liquid crystal display device as claimed in claim 1, wherein the light guide layer comprises a light incident surface at the peripheral edge thereof, and the light source is disposed adjacent to the light incident surface.

3. The liquid crystal display device as claimed in claim 1, wherein the light guide layer comprises a bottom surface at a side thereof farthest from the liquid crystal panel, and the bottom surface has a plurality of reflective structures provided thereat.

4. The liquid crystal display device as claimed in claim 3, wherein the reflective structures are pattern dots.

5. The liquid crystal display device as claimed in claim 3, further comprising a reflective plate adjacent the bottom surface of the light guide layer.

6. The liquid crystal display device as claimed in claim 1, wherein the polarizer further comprises a diffusion layer sandwiched between the polarizing layer and the light guide layer.

7. The liquid crystal display device as claimed in claim 1, wherein the light guide layer comprises a top surface at a side thereof farthest from the liquid crystal panel, and the top surface has a plurality of reflective structures provided thereat.

8. The liquid crystal display device as claimed in claim 7, wherein the reflective structures comprise grooves.

9. The liquid crystal display device as claimed in claim 8, wherein the polarizer further comprises a retardation film, and the retardation film is adjacent to the main face of the liquid crystal panel.

10. The liquid crystal display device as claimed in claim 1, wherein the liquid crystal panel is a transmission type liquid crystal panel or a transflective type liquid crystal panel.

11. The liquid crystal display device as claimed in claim 1, wherein the liquid crystal panel is a reflection type liquid crystal panel.

12. The liquid crystal display device as claimed in claim 1, wherein the light guide layer is made of triacetyl cellulose.

13. The liquid crystal display device as claimed in claim 1, wherein the light guide layer is made of material having high light transparence.

14. The liquid crystal display device as claimed in claim 1, wherein the light guide layer is made of material having high mechanical strength.

15. A liquid crystal display device, comprising:
a liquid crystal panel;
a light source; and
an optical member;
wherein the optical member comprises a light guide layer configured for guiding and converting light beams emitted from the light source to a substantially planar light source, and a polarizing layer configured for polarizing light of the substantially planar light source such that the polarized light illuminates the liquid crystal panel.

16. The liquid crystal display device as claimed in claim 15, wherein the light guide layer comprises a bottom surface at a side thereof farthest from the liquid crystal panel, and the bottom surface has a plurality of reflective structures provided thereat.

17. The liquid crystal display device as claimed in claim 16, wherein the reflective structures are pattern dots.

18. The liquid crystal display device as claimed in claim 15, wherein the light guide layer comprises a top surface at a side thereof farthest from the liquid crystal panel, and the top surface has a plurality of reflective structures provided thereat.

19. The liquid crystal display device as claimed in claim 16, wherein the reflective structures comprise grooves.

20. The liquid crystal display device as claimed in claim 15, wherein the liquid crystal panel is one of the transmission type liquid crystal panel, a transflective type liquid crystal panel, and a reflection type liquid crystal panel.
